(19) United States
(12) Patent Application Publication
(10) Pub. No.: US 2021/0016251 A1
(43) Pub. Date: Jan. 21, 2021

(54) COMPOSITION BASED ON OXIDES OF CERIUM, OF NIOBIUM AND, OPTIONALLY, OF ZIRCONIUM AND USE THEREOF IN CATALYSIS

(71) Applicant: RHODIA OPERATIONS, Aubervilliers (FR)

(72) Inventors: Julien HERNANDEZ, Antony (FR); Rui Miguel JORGE COELHO MARQUES, Shanghai (CN); Emmanuel ROHART, Lyon Cedex (FR)

(21) Appl. No.: 16/933,954

(22) Filed: Jul. 20, 2020

Related U.S. Application Data
(63) Continuation of application No. 13/808,804, filed on Mar. 27, 2013, now abandoned.

(30) Foreign Application Priority Data
Jul. 7, 2010 (FR) 1002859

(51) Int. Cl. B01J 23/20; B01J 37/03; C01G 33/00; B01J 23/00; C01F 17/30; C01F 17/206

(52) U.S. Cl. CPC B01J 23/20; B01J 37/031; C01G 33/00; C01G 33/006; Y02C 20/10; C01F 17/30; C01F 17/206; B01J 2523/00; C01P 2006/13; B01J 23/002

(57) ABSTRACT

A composition based on cerium and niobium oxide in a proportion of niobium oxide of 2% to 20% is described. This composition can include zirconium oxide, optionally 50% of cerium oxide, 2% to 20% of niobium oxide, and at most 48% of zirconium oxide. Also described, is the use of the composition for treating exhaust gases.

The present invention relates to a composition based on oxides of cerium, of niobium and optionally of zirconium and to its use in catalysis, in particular for the treatment of exhaust gases.

“Multifunctional” catalysts are currently used for the treatment of exhaust gases from internal combustion engines (automobile afterburning catalysis). The term “multifunctional” is understood to mean catalysts capable of carrying out not only oxidation, in particular of carbon monoxide and hydrocarbons present in exhaust gases, but also reduction, in particular of nitrogen oxides also present in these gases (“three-way” catalysts). Zirconium oxide and cerium oxide today appear as two particularly important and advantageous constituents tor catalysts of this type.

In order to be effective, these catalysts have to exhibit in particular a good reducibility. The term “reducibility” is understood to mean, here and for the remainder of the description, the ability of the catalyst to be reduced in a reducing atmosphere and to be reoxidized in an oxidizing atmosphere. This reducibility can be measured fox example, by a consumption of hydrogen within a given temperature range. It is due to the cerium in the case of the compositions of the type of those of the invention, cerium having the property of being reduced or of being oxidized.

Furthermore, these products nave to exhibit a satisfactory acidity which makes possible, for example, better resistance to sulfation.

Finally, in order to be effective, these catalysts have to exhibit a specific surface which remains sufficient at high temperature.

The object of the invention is to provide a composition which exhibits a satisfactory reducibility in combination with a good acidity and which has a specific surface which remains suitable for use in catalysis.

With this aim, the composition according to the invention is based on cerium oxide and it is characterized in that it comprises niobium oxide with the following proportions by weight:

niobium oxide: from to 20%;
the remainder as cerium oxide.

Other characteristics, details and advantages of the invention will become even more fully apparent on reading the description which will follow and the various concrete but nonlimiting examples intended to illustrate it.

For the present description, the term “rare earth metal” is understood to mean the elements of the group consisting of yttrium and the elements of the Periodic. Table with an atomic number of between 57 and 71 inclusive.

The term “specific surface” is understood to mean the B.E.T. specific surface determined by nitrogen adsorption in accordance with standard ASTM D 3663-78 established on the basis of the Brunauer-Emmett-Teller method described in the periodical “The Journal of the American Chemical Society, 60, 309 (1938)”.

The specific surface values which are indicated for a given temperature and a given duration correspond, unless otherwise indicated, so the calcinations under air at a stationary phase at this temperature and over the period or time indicated.

The calcinations mentioned in the description are calcinations under air, unless otherwise indicated. The calcination time which is indicated for a temperature corresponds to the duration of the stationary phase at this temperature.

The contents or proportions are given by weight and by oxide (in particular CeO₂, Ln₂O₃, Ln denoting a trivalent rare earth metal, Pr₆O₁₁ in the specific case of praseodymium, Nb₂O₅ in the case of niobium), unless otherwise indicated.

It is also specified, for the continuation of the description, that, unless otherwise indicated, in the ranges of values which are given, the values at the limits are included.

The composition of the invention is characterized first of all by the nature and the proportions of its constituents. Thus, and according to a first embodiment, it is based on cerium and on niobium, these elements being present in the composition generally in the form of oxides. Furthermore, these elements are present in the specific proportions which are given above.

The cerium oxide of the composition can be stabilized (the term “stabilized” is understood here to mean stabilization of the specific surface) by at least one rare earth metal other than cerium, in the oxide form. This rare earth metal can more particularly be yttrium, neodymium, lanthanum or praseodymium. The content of stabilizing rare earth metal oxide is generally at most 20%, preferably when the rare earth metal is lanthanum, more particularly at most 15% and preferably at most 10%, by weight. The content of stabilizing rare earth metal oxide is not critical but it is generally at least 1%, more particularly at least 2%. This content is expressed as oxide of the rare earth metal, with respect to the weight of the cerium oxide/stabilizing rare earth metal oxide combination.

The cerium oxide can also be stabilized, this stabilization still referring to the specific surface, by an oxide chosen from silica, alumina and titanium oxide. The content of this stabilizing oxide can be at most 10% and more particularly at most 5%. The minimum content can be at least 1%. This content is expressed as stabilizing oxide, with respect to the weight of the cerium oxide/stabilizing oxide combination.

According to another embodiment of the invention, the composition of the invention comprises three constituent elements, here also in the form of oxides, which are cerium, niobium and zirconium.

The respective proportions of these elements are then as follows:

cerium oxide: at least 50%;
niobium oxide: from 2 to 20%;
zirconium oxide: up to 48%.

The minimum proportion of zirconium oxide in the case of this second embodiment of invention is preferably at least 10%, more particularly at least 15%. The maximum content of zirconium oxide can more particularly be at most 40%; and more particularly still at most 30%.

According to a third embodiment of the invention, the composition of the invention additionally comprises at least one oxide of an element M chosen from the group consisting of tungsten, molybdenum, iron, copper, silicon, aluminum, manganese, titanium, vanadium and the rare earth metals other than cerium, with the following proportions by weight:

cerium oxide: at least 50%;
niobium oxide: from 2 to 20%;
oxide of the element M: up to 20%;
the remainder as zirconium oxide.

This element M can in particular act as stabilizer of the surface of the mixed oxide of cerium and zirconium or can also improve the reducibility of the composition. For the continuation of the description, it should be understood that, if, for reasons of simplicity, only one element M is mentioned, it is clearly understood that the invention applies to the case where the compositions comprise several elements M.

The maximum proportion of oxide of the element M in the case of the rare earth metals and tungsten can more particularly be at most 15% and more particularly still at most 10% by weight of oxide of the element M (rare earth metal and/or tungsten). The minimum content is at least 1% and more particularly at least 2%, the contents given above being expressed with respect to the cerium oxide/zirconium oxide/oxide of the element M combination.

In the case here M is neither a rare earth metal nor tungsten, the content of the oxide of the element M can more particularly be at most 10% and more particularly still at most 5%. The minimum content can be at least 1%. This content is expressed as oxide of the element M, with respect to the cerium oxide/zirconium oxide/oxide of the element M combination.

In the case of the rare earth metals, the element M can more particularly be yttrium, lanthanum, praseodymium and neodymium.

For the various embodiments described above, the proportion of niobium oxide can more particularly be between 3% and 15% and more particularly still between 4% and 10%.

In the case of the compositions according to the second or third embodiment and according to an advantageous alternative form, the content of cerium can be at least 65%, more particularly at least 70% and more particularly still at least 75% and that of niobium can be between 2% and 12% and more particularly between 2% and 10%. The compositions according to this alternative form exhibit a high acidity and a high reducibility.

Still for these various embodiments, the proportion of niobium can more particularly still be less than 10% and, for example, between a minimum value which can be 2% or 4% and a maximum value which is strictly less than 10%, for example at most 9% and more particularly at most 8% and more particularly still at most 7%. This content of niobium is expressed as weight of niobium oxide, with respect to the weight of the entire composition. The values for the proportions of niobium which have just been given, in particular that strictly less than 10%, apply to the advantageous alternative form according to the second or the third embodiment which was described above.

Finally, the compositions of the invention exhibit a specific surface which is sufficiently stable, that is to say sufficiently elevated at high temperature, in order for them to be able to be used in the field of catalysis.

Thus, generally, the compositions according to the first embodiment exhibit a specific surface after calcination at 800° C. for 4 hours which is at least 15 m²/g, more particularly at least 20 m²/g and more particularly still at least 30 m²/g. For the compositions. according to the second and the third embodiment, this surface, under the same conditions, is generally at least 20 m²/g and more particularly at least 30 m²/g. For the three embodiments, the compositions of the invention can exhibit a surface ranging up to approximately 55 m² /g, still under the same calcination conditions. The compositions according to the invention, in the case where they comprise an amount of niobium of at least 10%, and according to an advantageous embodiment, can exhibit a specific surface, after calcination at 800° C. for 4 hours, which is at least 35m²/g, more particularly at least 40 m²/g.

Still for the three embodiments, the compositions of the invention can exhibit a specific surface, after calcination at 900° C. for 4 hours, which is at least 10 m²/g, more particularly at least 15 m²/g. Under the same calcination conditions, they can have specific surfaces ranging up to approximately 30 m²/g.

The compositions of the invention, for the three embodiments, can exhibit a specific surface, after calcination at 1000° C. for 4 hours, of at least 2 m²/g, more particularly of at least 3 m²/g and more particularly still of at least 4 m²/g. Under the same calcination conditions, they can have surfaces ranging up to approximately. 10 m²/g.

The compositions of the invention exhibit a high acidity which can be measured by a TPD analytical method, which will be described later, and which is at least 5×10⁻², more particularly at least 6×10⁻² and more particularly still at least 6.4×10⁻². This acidity can in particular be at least 7×10⁻², this acidity being expressed in ml of ammonia per m² of product. The surface taken into account here is the value, expressed in m², of the specific surface of the product after calcination at 800° C. for 4 hours. Acidities of at least approximately 9.5×10⁻² can be obtained.

The compositions of the invention also exhibit significant reducibility properties. These properties can be measured by the temperature programmed reduction (TPR) measurement method, which will be described later. The compositions of the invention exhibit a reducibility of at least 15, more particularly of at least 20 and more particularly still of at least 30. This reducibility is expressed in ml of hydrogen per g of product. The reducibility values given above are given for compositions which have been subjected to a calcination at 800° C. for 4 hours.

The compositions can be provided in the form of a solid solution of the oxides of niobium, of the stabilizing element, in the case of the first embodiment, of zirconium and of the element M in cerium oxide. There is then observed, in this case, the presence of a single phase in X-ray diffraction, corresponding to the cubic phase of the cerium oxide. This solid solution characteristic applies generally to the compositions which have been subjected to a calcination at 800° C. for 4 hours or also at 900° C. for 4 hours.

The invention also relates to the case where the compositions are essentially composed of oxides of the abovementioned elements, cerium, niobium and, if appropriate, zirconium and the element M. The term “essentially composed” is understood to mean that the composition under consideration comprises only the oxides of the abovementioned elements and that it does not comprise an oxide of another functional element, that is to say another functional element capable of having a positive influence on the reducibility and/or acidity and/or stability of the composition. On the other hand, the composition can comprise elements, such as impurities, which can in particular originate from its process of preparation, for example from starting materials or starting reactants used.

The compositions of the invention can be prepared by the known process of impregnation. Thus, a cerium oxide or a mixed oxide of cerium and zirconium prepared beforehand is impregnated with a solution comprising a niobium compound, for example an oxalate or an ammonium niobium oxalate. In the case of the preparation of a composition which additionally comprises an oxide of the element M, use is made, for the impregnation, of a solution which comprises a compound of this element M in addition to the niobium compound. The element M can also be present in the starting cerium oxide, which is impregnated.

Use is more particularly made of dry impregnation. Dry impregnation consists in adding to the product to be impregnated, a volume of an aqueous solution of the impregnating element which as equal to the pore volume of the solid to be impregnated.

The cerium oxide or the mixed oxide of cerium and zirconium has to exhibit specific surface properties which render it suitable for use in catalysis. Thus, this surface must be stable, that is to say that it must exhibit a satisfactory value for such a use even at high temperature.

Such oxides are well known. Use may in particular be made, for the cerium oxides, or those described in patent applications EP 0 153 227, EP 0 388 567 and. EP 0 300 852. Use may be made, for the cerium oxides stabilized by an element, such as rare earth metals, silicon, aluminum and iron, of the products described in EP 2 160 357, EP 547 924, EP 588 691 and EP 207 857. Mention may be made, for the mixed oxides of cerium and zirconium with optionally an element M, in particular in the case where M is a rare earth metal, as products which are suitable for the present invention, of those described in patent applications EP 605 274, EP 1 991 354, EP 1 660 406, EP 1 603 657, EP 0 906 244 and EP 0 735 984. Thus, if necessary, reference may be made, for the implementation of the present invention, to the combined descriptions of the abovementioned patent applications.

The compositions of the invention can also be prepared by a second process which will be described below.

This process comprises the following stages:

(a1) a suspension of a niobium hydroxide is mixed with a solution comprising salts of cerium and, if appropriate, of zirconium and of the element M;
(b1) the mixture thus formed is brought together with a basic compound, whereby a precipitate is obtained;
(c1) the precipitate is separated from the reaction medium and calcined.

The first stage of this process employs a suspension of a niobium hydroxide. This suspension can be obtained by reacting a niobium salt, such as a chloride, with a base, such as aqueous ammonia, in order to obtain a niobium hydroxide precipitate. This suspension can also be obtained by reaction of a niobium salt, such as potassium or sodium niobate, with an acid, such as nitric acid, in order to obtain a niobium hydroxide precipitate.

This reaction can be carried out in a mixture of water and alcohol, such as ethanol. The hydroxide thus obtained is washed by any known means and is subsequently resuspended in water in the presence of a peptizing agent, such as nitric acid.

The second stage (b1) of the process consists in mixing the niobium hydroxide suspension with a solution of a cerium salt. This solution can additionally comprise a salt of zirconium and also of the element M, in the case of the preparation of a composition which additionally comprises a zirconium oxide or alternatively oxide of zirconium and of this element M. These salts can be chosen from nitrates, sulfates, acetates, chlorides or ceric ammonium nitrate.

Mention may thus be made, as examples of zirconium salts, of zirconium sulfate, zirconyl nitrate or zirconyl chloride. Zirconyl nitrate is most generally used.

When use is made of a salt of cerium in the III form, it is preferable to introduce an oxidizing agent, for example aqueous hydrogen peroxide solution, into the solution of the salts.

The various salts of the solution are present in the stoichiometric proportions necessary in order to obtain the desired composition.

The mixture formed from the suspension of niobium hydroxide and from the solution of the salts of the other elements is brought together with a basic compound.

Use may be made, as base or basic compound, of products of the hydroxide type. Mention may be made of alkali metal or alkaline earth metal hydroxides. Use may also be made of secondary, tertiary or quaternary amines. However, amines and aqueous ammonia may be preferred insofar as they reduce the risks of contamination by alkali metal or alkaline earth metal cations. Mention may also be made of urea. The basic compound can more particularly be used in the form of a solution.

The reaction between the abovementioned mixture and the basic compound preferably takes place continuously reactor. This reaction thus takes place by continuously introducing the mixture and the basic compound and by withdrawing, also continuously, the reaction product.

The precipitate which is obtained is separated from the reaction medium by any conventional solid/liquid separation technique, such as, for example, filtration, settling, draining or centrifuging. This precipitate can be washed and then calcined at a temperature sufficient to form the oxides, for example at least 500° C.

The compositions of the invention can also be prepared by a third process which comprises the following stages:

(a2) in a first stage, a mixture is prepared in liquid medium, which comprises a cerium compound and, if appropriate, a compound of zirconium and of the element M for the preparation of the compositions which comprise zirconium oxide or zirconium oxide and an oxide of the element M;
(b2) said mixture and a basic compound are brought together, whereby a suspension comprising a precipitate is obtained;

(c2) this suspension is mixed with a solution of a niobium salt;

(d2) the solid is separated from the liquid medium;
(e2) said solid is calcined.

The cerium compound can be a cerium(III) or cerium(IV) compound. The compounds are preferably soluble compounds, such as salts. That which was said above for the salts of cerium, of zirconium and of the element M also applies here. It is the same for the nature of the basic compounds. The various compounds of the starting mixture of the first stage are present in the stoichiometric proportions necessary in order to obtain the desired final composition.

The medium of the first stage is generally water.

The starting mixture of the first stage can be obtained without distinction either from compounds initially in the solid state, which will subsequently be introduced into a vessel heel, for example of water, or alternatively directly from solutions of these compounds and then mixing of said solutions in any order.

The reactants in the second stage (b2) can be introduced in any order, it being possible for the basic compound to be introduced into the mixture or vice versa or it also being possible for the reactants to be introduced simultaneously into the reactor.

The addition can be carried out all at once, gradually or continuously, and it is preferably carried out with stirring. This operation can be carried out at a temperature between ambient temperature (18-25° C.) and the reflux temperature of the reaction medium, it being possible for the latter to reach 120° C., for example. It is preferably carried out at ambient temperature.

As in the case of the first process, it may be noted that it is possible, in particular in the case of the use of a cerium(III) compound, to add an oxidizing agent, such as an aqueous hydrogen peroxide solution, either to the starting mixture or during the introduction of the basic compound.

At the end of the: second stage (b2) of addition of the basic compound, the reaction medium can optionally be kept stirred for a little while further, in order to complete the precipitation.

It is also possible, at this stage of the process, to carry out a maturing. This can be carried out directly on the reaction medium obtained after bringing together with the basic compound or on a suspension obtained after resuspending the precipitate in water. The maturing is carried out by heating the medium. The temperature at which the medium is heated is at least 40° C., more particularly at least 60° C. and more particularly at least 100° C. The medium is thus maintained at a constant temperature for a period of time which is usually at least 30 minutes and more particularly at least 1 hour. The maturing can be carried out at atmospheric pressure or optionally at a higher pressure and at a temperature of greater than 100° C. and in particular between 100° C. and 150° C.

The following stage (c2) of the process consists in mixing the suspension obtained on conclusion of the preceding stage with a solution of a niobium salt. Mention may be made, as niobium salt, of niobium chloride, potassium or sodium niobate and, very particularly here, niobium oxalate and ammonium niobium oxalate.

This mixing is preferably carried out at ambient temperature.

The following stages of the process, (d2) and (e2), consist in separating the solid from the suspension obtained in the preceding stage, in optionally washing this solid and in then calcining it. These stages take place in an identical manner to what was described above for the second process.

In the case of the preparation of compositions which comprise oxide of the element M, the third process can exhibit an alternative form in which the compound of this element M is not present in the stage (a2). The compound of the element M is then introduced in stage (c2), either before or after the mixing with the niobium solution or alternatively at the same time.

The third process can also be carried out according to another alternative form which, on conclusion of stage (c2), an additive chosen from anionic surfactants, nonionic surfactants, polyethylene glycols, carboxylic acids and their salts and surfactants of the carboxymethylated ethoxylates of fatty alcohols type is added to the medium resulting from this stage. Stage (d2) is subsequently carried out. It is also possible to carry out stages (c2) and (d2) and then to add the abovementioned additive to the solid resulting from the separation.

Reference may be made, as regards more specifically the nature of the additive, to the description of WO 2004/085039. Mention may more particularly be made, as nonionic surfactant, of the products sold under the Igepal®, Dowanol®, Rhodamox® and Alkamide® brands. Mention may thus in particular be made, as regards the carboxylic acids, of formic, acetic, propionic, butyric, isobutyric, valeric, caproic, caprylic, capric, lauric, myristic and palmitic and their ammoniacal salts.

Finally, the compositions of the invention which are based on oxides of cerium, of niobium and of zirconium and optionally of an oxide of the element M can also be prepared by a fourth process which will be described below.

This process comprises the following stages:

(a3) a mixture is prepared in a liquid medium, which mixture comprises a compound of zirconium and a compound of cerium and, if appropriate, of the element M;
(b3) said mixture is heated at a temperature of greater than 100° C.;
(c3) the reaction medium obtained on conclusion of the heating is brought to a basic pH;
(c′3) a maturing of the reaction medium is optionally carried out;
(d3) this medium is mixed with a solution of a niobium salt;
(e3) the solid is separated from the liquid medium;
(f3) said solid is calcined.

The first stage of the process consists in preparing a mixture, in a liquid medium, of a compound of zirconium and of a compound of cerium and, if appropriate, of the element M. The various compounds of the mixture are present in the stoichiometric proportions necessary in order to obtain the desired final composition.

The liquid medium is generally water.

The compounds are preferably soluble compounds. They can in particular be salts of zirconium, of cerium and of the element M as described above.

The mixture can be obtained without distinction either from compounds initially in the solid state, which will be subsequently introduced into a vessel heel, for example of water, or alternatively directly from solutions of these compounds and then mixing of said solutions in any order.

The initial mixture thus being obtained, it is subsequently heated, in accordance with the second stage (b3) of this fourth process.

The temperature at which this heat treatment, also known as thermal hydrolysis, is carried out is greater than 100° C. It can thus be between 100° C. and the. critical temperature of the reaction medium, in particular between 100 and 350° C., preferably between 100 and 200° C.

The heating operation can be carried out by introducing the liquid medium into a closed chamber (closed reactor of the autoclave type), the necessary pressure then resulting only from the heating alone of the reaction medium (autogenous pressure). Under the temperature conditions given above, and in an aqueous medium, it can thus be specified, by way of illustration, that the pressure in the closed reactor can vary between a value of greater than 1 bar (10⁵ Pa) and 165 bar (1.65×10⁷ Pa) , preferably between 5 bar (5×10⁵ Pa) and 165 bar (1.65×10⁷ Pa). It is, of course, also possible to exert an external pressure which is then added to that resulting from heating.

It is also possible to carry out the heating in an open reactor for temperatures in the vicinity of 100° C.

The heating can be carried out either under air or under an inert gas atmosphere, the inert gas preferably being nitrogen.

The duration of the treatment is not critical and can thus vary within wide limits, for example between 1 and 48 hours, preferably between 2 and 24 hours. Likewise, the rise in temperature takes place at a rate which is not critical and it is thus possible to reach the set reaction temperature by heating the medium for, for example, between 30 minutes and. 4 hours, these values being given entirely by way of indication.

On conclusion of this second stage, the reaction medium thus obtained is brought to a basic pH. This operation is carried out by adding a base, such as, for example, an aqueous ammonia solution, to the medium.

The term “basic pH” is understood to mean a value of the pH of greater than 7 anal preferably of greater than 8.

Although this alternative form is not preferred, it is possible to introduce the element M, in particular in the form which has been described above, into the reaction mixture obtained on conclusion of the heating, in particular during the addition of the base.

On conclusion of the heating stage, a solid precipitate is recovered, which precipitate can be separated from its medium as described above.

The product as recovered can subsequently be subjected to washing operations, which are then carried out with water or optionally with a basic solution, for example an aqueous ammonia solution. The washing operation can be carried out by resuspending the precipitate in water and keeping the suspension thus obtained at a temperature which can range up to 100° C. In order to remove the residual water, the washed product can also be dried, for example in an oven or by spraying, this being carried out at a temperature which can vary between 80 and 300° C., preferably between 100 and 200° C.

According to a specific alternative form of the invention, the process comprises a maturing (stage c′3).

The maturing is carried out under the same conditions as those which were described above for the third process.

The maturing can also be carried out on a suspension obtained after resuspending the precipitate in water. It is possible to adjust the pH of this suspension to a value of greater than 7 and preferably of greater than 8.

It is possible to carry out several maturing operations. Thus, the precipitate obtained after the maturing stage and optionally a washing operation can be resuspended in water and then another maturing of the medium thus obtained can be carried out. This maturing operation is carried out under the same conditions as those which were described for the first maturing operation. Of course, this procedure can be repeated several times.

The following stages of this fourth process, (d3) to (f3), that is to say the mixing with the solution of niobium salt, the solid/liquid separation and the calcination, are carried out in the same way as for the corresponding stages of the second and third processes. That which was described above for these stages thus applies here.

The compositions of the invention as described above, that is to say the compositions based on oxides of cerium, of niobium and optionally of zirconium and of the element, are provided in the form of powders but they can optionally be shaped in order to be provided in the form of granules, balls, cylinders honeycombs of variable sizes.

These compositions can be used with any material normally employed in the field of catalyst formulation, that is to say in particular a material chosen from thermally inert materials. This material can be chosen from alumina, titanium oxide, cerium oxide, zirconium oxide, silica, spinels, zeolites, silicates, crystalline silicoaluminum phosphates or crystalline aluminum phosphates.

The compositions of the invention, still as described above, can also be used in catalytic systems comprising a coating (wash coat) having catalytic properties and based on these compositions with a material of the type of those mentioned above, the coating being deposited on a substrate of the, for example, monolith type, made of metal, for example Fercralloy, or of ceramic, for example of cordierite, of silicon carbide, of alumina titanate or of mullite.

This coating is obtained by mixing the composition with the material, so as to form a suspension, which will subsequently be deposited on the substrate.

In the case of the uses in catalysis, and in particular in the abovementioned catalytic systems, the compositions of the invention can be employed in combination with precious metals; they can thus optionally act as support for these metals. The nature of these metals and the techniques for the incorporation of the latter in the compositions are well known to a person skilled in the art. Far example, the metals can be platinum, rhodium, palladium, silver, gold or iridium. They can in particular be incorporated in the compositions by impregnation.

The catalytic systems and more particularly the compositions of the invention can have a great many applications.

These catalytic systems and more particularly the compositions of the invention can have a great many applications. They are thus particularly well suited to, and thus can be used in, the catalysis of various reactions, such as, for example, dehydration, hydrosulfurization, hydrodenitrification, desulfurization, hydrodesulfurization, dehydrohalogenation, reforming, steam reforming, cracking, hydrocracking, hydrogenation, dehydrogenation, isomerization, dismutation, oxychlorination, dehydrocyclization of hydrocarbons or other organic compounds, oxidation and/or reduction reactions, the Claus reaction, treatment of exhaust gases from internal combustion engines, demetallation, methanation, the shift conversion or the catalytic oxidation of the soot emitted by internal combustion engines, such as diesel engines or gasoline engines operating under lean burn conditions. The systems and compositions of the invention can be used as catalysts in a process employing a water gas reaction, a steam reforming reaction, an isomerization reaction or a catalytic cracking reaction. Finally, the catalytic systems and the compositions of the invention can be used as NOₓ scavengers.

The catalytic systems and the compositions of the invention can more particularly be used in the following applications.

A first application relates to a process for the treatment of a gas in which use is made of a system or a composition of the invention as catalyst for the oxidation of the CO and hydrocarbons present in this gas.

According to a second application, the systems and compositions of the invention can also be used for the adsorption of NOₓ and CO₂, still in the treatment of gases.

The gas which is treated in these two applications can be a gas originating from an internal combustion engine (moving or stationary).

According to another application, the compositions of the invention can be used in the formulation of catalysts for three-way catalysis in the treatment of gasoline engine exhaust gases and the catalytic systems of the invention can be used for carrying out this catalysis.

Another application relates to the use of the systems and compositions of the invention in a process for the treatment of a gas for the purpose of breaking down the N₂O.

It is known that N₂O occurs in a significant amount in the gases emitted by some industrial plants. In order to avoid discharges of N₂O, these gases are treated so as to break down the N₂O into oxygen and nitrogen, before being discharged to the atmosphere. The systems and compositions of the invention can be used as catalysts for this decomposition reaction, very particularly in a process for the preparation of nitric acid or adipic acid.

Examples now be given.

### EXAMPLE 1

This example relate to the preparation of a composition according to the invention comprising cerium oxide, zirconium oxide and niobium oxide in the following respective proportions by weight: 63.0/27.0/10.0.

First of a niobium hydroxide suspension prepared according to the following process.

1200 g of anhydrous ethanol are introduced into a 5 liter reactor equipped with a stirrer and a reflux condenser. 295 of niobium(V) chloride powder are added over 20 minutes with stirring. 625 g of anhydrous ethanol are subsequently added. The medium is left standing for 12 hours.

50 g of deionized water are introduced into the reactor and the medium is brought to reflux at 70° C. for 1 hour. Cooling is allowed to take place. This solution is named A.

870 q of aqueous ammonia solution (29.8% of NH₃) are introduced into a 6 liter reactor equipped with a stirrer. All of the solution A and 2250 ml of deionized water are simultaneously introduced over 15 minutes with stirring. The suspension is recovered and washed several times by centrifuging. The centrifugate is named B.

2.4 liters of a 1 mol/l nitric acid solution are introduced into a 6 liter reactor equipped with a stirrer. The centrifugate B is introduced into the reactor with stirring. Stirring is maintained for 12 hours. The pH is 0.7. The concentration of Nb₂O₅ is 4.08%. This suspension is named C.

An aqueous ammonia solution D is subsequently prepared by introducing 1040 g of a concentrated aqueous ammonia solution (29.8% of NH₃) into 6690 g of deionized water.

A solution E is prepared by mixing 4250 g of deionized water, 1640 g of a cerium(III) nitrate solution (30.32% of CeO₂), 1065 a of a zirconium oxynitrate solution (20.04% of ZrO₂), 195 g of an aqueous hydrogen peroxide solution (50.30% of H₂O₂) and 1935 g of the suspension C (4.08% of Nb₂O₅). This solution E is set stirring.

The solution D and the solution E are simultaneously added at a flow rate of 3.2 liters/hour to a stirred 4 liter reactor equipped with an overflow. After starting up the plant, the precipitate is recovered in a keg. The pH is stable and in the vicinity of 9.

The suspension is filtered and the solid product obtained is washed and calcined at 800° C. for 4 hours.

### Example 2

This example relates to the preparation of a composition according to the invention comprising cerium oxide, zirconium oxide and niobium oxide in the following respective proportions by weight: 55.1/40.0/4.9.

The preparation is carried out of an aqueous ammonia solution D as in example 1 and with the same compounds but in the following proportions:

concentrated aqueous ammonia solution: 978 g
deionized water: 6760 g.

The preparation is also carried out of a solution E as in example 1 and with the same compounds but in the following proportions:

deionized water: 5000 g
cerium(III) nitrate solution: 1440 g
zirconium oxynitrate solution: 1580 g
aqueous hydrogen peroxide solution: 172 g
suspension C: 950 g

The subsequent procedure is as in example 1.

### Example 3

This example relates to the preparation of a composition according to the invention comprising cerium oxide, zirconium oxide and niobium oxide in the following respective proportions by weight 54.0/39.1/6.9.

The preparation is carried out of an aqueous ammonia solution C as in example 1 and with the same compounds but in the following proportions:

concentrated aqueous ammonia solution: 1024 g
deionized water: 6710 g.

The preparation is also carried out of a solution E as in example 1 and with the same compounds but in the following proportions:

deionized water: 4580 g
cerium(III) nitrate solution: 1440 g
zirconium oxynitrate solution: 1580 g
aqueous hydrogen peroxide solution: 172 g
suspension C: 1370 g

The subsequent procedure is as in example 1.

### Example 4

This example relates to the preparation of a composition according to the invention comprising cerium oxide, zirconium oxide and niobium oxide the following respective proportions by weight: 77.9/19.5/2.6.

The preparation is carried out of an aqueous ammonia solution D as in example 1 and with the same compounds but in the following proportions:

concentrated aqueous ammonia solution: 966 g
deionized water: 6670 g.

The preparation is also carried out of a solution E as in example 1 and with the same compounds but in the following proportions:

deionized water: 5620 g
cerium(III) nitrate solution: 2035 g
zirconium oxynitrate solution: 770 g
aqueous hydrogen peroxide solution: 242 g
suspension C: 505 g

The subsequent procedure is as in example 1.

### Example 5

This example relates to the preparation of a composition according to the invention comprising cerium oxide, zirconium oxide and niobium oxide in the following respective proportions by weight: 76.6/19.2/4.2.

The preparation is carried out of an aqueous ammonia solution D as in example 1 and with the same compounds but in the following proportions:

concentrated aqueous ammonia solution: 1002 g
deionized water: 6730 g.

The preparation is also carried out of a solution E as in example 1 and with the same compounds but in the following proportions:

deionized water: 5290 g
cerium(III) nitrate solution: 2635 g
zirconium oxynitrate solution: 770 g
aqueous hydrogen peroxide solution: 242 g
suspension C. 836 g

The subsequent procedure is as in example 1.

### Example 6

This example relates to the preparation of a composition according to the invention comprising cerium oxide, zirconium oxide and niobium oxide in the following respective proportions by weight: 74.2/18.6/7.2.

The preparation is carried out of an aqueous ammonia solution D as in example 1 and with the same compound but in the following proportions:

concentrated aqueous ammonia solution: 1068 g
deionized water: 6650 g.

The preparation is also carried out of a solution E as in example 1 and with the same compounds but in the following proportions:

deionized water: 4680 g
cerium(III) nitrate solution: 2035 g
zirconium oxynitrate solution: 770 g
aqueous hydrogen peroxide solution: 242 g
suspension C: 1470 g

The subsequent procedure is as in example 1.

### Example 7

This example relates to the preparation of a composition according to the invention comprising cerium oxide, zirconium oxide and niobium oxide in the following respective proportions by weight: 72.1/18.0/9.9.

An ammonium niobium(V) oxalate solution is prepared by dissolving 192 g of ammonium niobium(V) oxalate in 300 g of deionized water under hot conditions.

This solution is maintained at 50° C. The concentration of Nb₂O₅ in this solution is 14.2%.

This solution is subsequently introduced onto a powder formed of a mixed oxide of cerium and zirconium (composition by weight CeO₂/ZrO₂ 80/20, specific surface, after calcination at 800° C. for 4 hours, of 59 m²/g) until the pore volume is saturated.

The impregnated powder is subsequently calcined at 800° C. (stationary phase of 4 hours).

### Example 8

This example relates to the preparation of a composition according to the invention comprising cerium oxide, zirconium oxide and niobium oxide in the following respective proportions by weight: 68.7/17.2/14.1.

The preparation is carried out of an aqueous ammonia solution D as in example 1 and with the same compounds but in the following proportions:

concentrated aqueous ammonia solution: 1148 g
deionized water: 6570 g.

The preparation is also carried out of a solution E as in example 1 and with the same compounds but in the following proportions:

deionized water: 3400 g
cerium(III) nitrate solution: 1880 g
zirconium oxynitrate solution: 710 g
aqueous hydrogen peroxide solution: 224 g
suspension C: 2870 g

The subsequent procedure is as in example 1.

### Example 9

This example relates to the preparation of a composition according to the invention comprising cerium oxide and niobium oxide in the following respective proportions by weight: :96.8/3.2.

The preparation is carried out of an aqueous ammonia solution D as in example 1 and: with the same compounds but in the following proportions:

concentrated aqueous ammonia solution: 990 g
deionized water: 6750 g.

The preparation is also carried out of solution E as in example 1 and with the same compounds but without zirconium oxynitrate and in the following proportions:

deionized water: 5710 g
cerium(III) nitrate solution: 2540 g
aqueous hydrogen peroxide solution: 298 g
suspension C: 625 g

The subsequent procedure is as in example 1.

### Example 10

This example relates to the preparation of a composition according to the invention comprising cerium oxide and niobium oxide in the following respective proportions by weight: 91.4/8.6.

The preparation is carried out of an aqueous ammonia solution D as in example 1 and with the same compounds but in the following proportions:

concentrated aqueous ammonia solution: 1110 g
deionized water: 6610 g

The preparation is also carried out of a Solution E as in example 1 and with the same compounds but without zirconium oxynitrate and in the following proportions:

deionized water: 4570 g
cerium(III) nitrate solution: 2540 g
aqueous hydrogen peroxide solution: 298 g
suspension C: 1775 g

The subsequent procedure is as in example 1.

### Example 11

This example relates to the preparation of a composition according to the invention comprising cerium oxide, zirconium oxide and niobium oxide in the following respective proportions by weight: 63.0/27.0/10.0.

A solution of zirconium and cerium(IV) nitrates is prepared by mixing 264 g of deionized water, 238 g of cerium(IV) nitrate solution (252 g/l of CeO₂) and 97 g of zirconium oxynitrate solution (261 g/l of ZrO₂. The concentration of oxide in this solution is 120 g/l.

373 g of deionized water and 111 g of aqueous ammonia solution (32% of NH₃) are introduced into a stirred 1.5 l reactor.

The solution of nitrates is introduced over 1 hour. The final pH is in the vicinity of 9.5.

The suspension thus prepared is matured at 95° C. for 2 hours. The medium is subsequently allowed to cool.

A niobium(V) oxalate solution is prepared by dissolving 44.8 g of niobium(V) oxalate in 130 g of deionized water under hot conditions.

This solution is maintained at 50° C. The concentration of Nb₂O₅ in this solution is 3.82%.

The niobium (V) oxalate solution is introduced over 20 minutes into the cooled suspension.

The suspension is filtered and washed.

The cake is subsequently introduced into a furnace and calcined at 800° C. (stationary phase of 4 hours).

### Example 12

This example relates to the preparation of a composition comprising cerium oxide, zirconium oxide and niobium oxide in the following respective proportions by weight: 63.3/26.7/10.0.

A solution of zirconium and cerium(IV) nitrates is prepared by mixing 451 g of deionized water, 206 g of cerium(IV) nitrate solution (252 g/l of CeO₂) and 75 g of zirconium oxynitrate solution (288 g/l of ZrO₂). The concentration of oxide in this solution is 80 g/l.

This solution of nitrates is introduced into an autoclave.

The temperature is raised to 100° C. The medium is kept stirred at 100° C. for 1 hour.

Cooling is allowed to take place.

The suspension is transferred into a stirred 1.5 l reactor.

A 6 mol/l aqueous ammonia solution is introduced with stirring until a pH in a vicinity of 9.5 is obtained.

The suspension is matured at 95° C. for 2 hours.

The medium is subsequently allowed to cool.

A niobium(V) oxalate solution is prepared by dissolving 39 g of niobium(V) oxalate in 113 g of deionized water under hot conditions.

This solution is maintained at 50° C. The Concentration of Nb₂O₅ in this solution is 3.84%.

The niobium oxalate solution is introduced over 20 minutes into the cooled suspension.

The pH is subsequently brought back to pH 9 by addition of an aqueous ammonia solution (32% of NH₃).

The suspension is filtered and washed. The cake is subsequently introduced into a furnace and calcined at 800° C. (stationary phase of 4 hours).

### Example 13

This example relates to the preparation of a composition comprising cerium oxide, zirconium oxide and niobium oxide in the following respective proportions by weight: 64.0/27.0/9.0.

The same procedure is employed as in example 12.

However, the niobium(V) oxalate solution is prepared by dissolving 35.1 g of niobium(V) oxalate in 113 g of deionized water under hot conditions. The concentration of Nh₂O₅ in this solution is 3.45%.

### Comparative Example 14

This example relates to the preparation of a composition comprising cerium oxide, zirconium oxide and niobium oxide in the following respective proportions by weight: 19.4/77.6/3.0.

The preparation is carried out of an aqueous ammonia solution as in example 1 and with the same compounds but in the following proportions:

concentrated aqueous ammonia solution: 940 g
deionized water: 6730 g.

The preparation is also carried out of a solution E as in example 1 and with the same compounds but in the following proportions:

deionized water: 5710 g
cerium(III) nitrate solution: 2540 g
aqueous hydrogen peroxide solution: 298 g
suspension C: 625 g

The subsequent procedure is as in example 1.

Mention is made, in the following table, for each of the compositions of the examples above, of:

the BET specific surface after calcination at 800° C. and 900° C. for 4 hours;
the acidity properties;
the reducibility properties.

Acidity

The acidity properties are measured by the TPD method, which is described below.

The probe molecule used to characterize the acid sites in TPD is ammonia.

### Preparation of the Sample:

The sample is brought to 500° C. under a stream of helium (30 ml/min) according to a temperature rise of 20° C./min and is maintained at this temperature for 30 minutes in order to remove the water vapor and to thus prevent the pores from blocking. Finally, the sample is cooled to 100° C. under a stream of helium at a rate of 10° C./min.

### Adsorption:

The sample is subsequently subjected to a stream (30 ml/min; of ammonia (5 vol % of NH₃ in helium at 100° C.) at atmospheric pressure for 30 minutes (up to saturation). The sample is subjected to a stream of helium for a minimum of 1 hour.

### Desorption

The TPD is carried out by performing a rise in temperature of 10° C./min until 700° C. is reached.

During the rise in temperature, the concentration of the desorbed entities, that is to say of ammonia, is recorded. The concentration of ammonia during the desorption phase is deduced by virtue of the calibration of the variation in the thermal conductivity of the gas stream measured at the outlet of the cell using a thermal conductivity detector (TCD).

In table 1, the amounts of ammonia are expressed in ml (standard temperature and pressure conditions)/m² (surface area at 800° C.) of composition.

The higher the amount of ammonia, the higher the surface acidity of the product.

Reducibility

The reducibility properties a e measured by carrying out a temperature programmed reduction (TPR) on a Micromeritics Autochem 2 device. This device makes it possible to measure the hydrogen consumption of a composition as a function of the temperature.

More specifically, hydrogen is used as reducing gas at 10% by volume in argon with a flow rate of 30 ml/min.

The experimental protocol consists in weighing out 200 mg of the sample into a pretared container.

The sample is subsequently introduced into a quartz cell containing quartz wool in the bottom. Finally, the sample is covered with quartz wool and positioned in the furnace of the measuring device.

The temperature program s as follows.:

rise in temperature from ambient temperature up to 900° C. with a rise gradient at 20° C./min under H₂ at 10 vol % in Ar.

During this program, the temperature of the sample is measured using a thermocouple placed in the quartz cell above the sample.

The hydrogen consumption during the reduction phase is deduced by virtue of the calibration of the variation in the thermal conductivity of the gas stream measured at the outlet of the cell using a thermal conductivity detector (TCD).

The hydrogen consumption is measured between 30° C. and It is given in table 1 in ml (standard temperature and pressure conditions) of H₂ per g of product.

The higher this hydrogen consumption, the better the reducibility properties of the product (redox properties).

TABLE 1

| Example No. | | | | TPD | TPR |
|---|---|---|---|---|---|
| Ce/Zr/Nb | Specific surface m²/g | | | ml/m²/ | ml H₂/q |
| in % | 800° C. | 900° C. | 1000° C. | (acidity) | (reducibility) |
| No. 1 | 35 | 17 | 4 | 6.5 × 10⁻² | 32.9 |
| 63.0/27.0/10.0 | | | | | |
| No. 2 | 41 | 19 | 7.8 | 6.4 × 10⁻² | 29.7 |
| 55.1/40.0/4.9 | | | | | |
| No. 3 | 38 | 16 | 6.2 | 7.3 × 10⁻² | 29.4 |
| 54.0/39.1/6.9 | | | | | |
| No. 4 | 37 | 12 | 5.8 | 8.7 × 10⁻² | 30.7 |
| 77.9/19.5/2.6 | | | | | |
| No. 5 | 30 | 14 | 5.6 | 6.9 × 10⁻² | 29.8 |
| 76.6/19.2/4.2 | | | | | |
| No. 6 | 28 | 15 | 3.9 | 9.4 × 10⁻² | 32.3 |
| 74.2/18.6/7.2 | | | | | |
| No. 7 | 31 | 17 | 3.7 | 8.3 × 10⁻² | 32.5 |
| 72.1/18.0/9.9 | | | | | |
| No. 8 | 32 | 12 | 3.9 | 7.8 × 10⁻² | 33.9 |
| 63.7/17.2/14.1 | | | | | |
| No. 9 | 19 | 15 | 4.5 | 9.1 × 10⁻² | 19.5 |
| 96.8/0/3.2 | | | | | |
| No. 10 | 34 | 15 | 4.1 | 8.9 × 10⁻² | 21 |
| 91.4/0/8.6 | | | | | |
| No. 11 | 36 | 16 | 4.3 | 7.5 × 10⁻² | 30.4 |
| 63.0/27.0/10.0 | | | | | |
| No. 12 | 47 | 15 | 4 | 7 × 10⁻² | 31.0 |
| 63.3/26.7/10.0 | | | | | |
| No. 13 | 48 | 16 | 4 | 7 × 10⁻² | 31.2 |
| 64.0/27.0/9.0 | | | | | |
| No. 14 | 52 | 31 | 4.1 | 7.6 × 10⁻² | 12.6 |
| comparative | | | | | |
| 19.4/77.6/3.0 | | | | | |

It should be remembered that the reducibility values in the table are given for compositions which have been subjected to a calcination at 800° C. for 4 hours.

It is seen, from table 1, that the compositions according to the invention simultaneously exhibit good reducibility properties and good acidity properties. The composition of the comparative example exhibits good acidity properties but the reducibility properties are far inferior to those of the compositions of the invention.

1. A composition comprising niobium oxide with the following proportions by weight:
niobium oxide: from 2% to 20%; and
the remainder as cerium oxide.

2. The composition as claimed in claim 1, wherein the composition further comprises zirconium oxide with the following proportions by weight:
cerium oxide: at least 50%;
niobium oxide: from 2% to 20%; and
zirconium oxide: up to 48%.

3. The composition as claimed in claim 2, wherein the composition further comprises at least one oxide of an element M selected from the group consisting of tungsten, molybdenum, iron, copper, silicon, aluminum, manganese, titanium, vanadium and a rare earth metal other than cerium, with the following proportions by weight:
cerium oxide: at least 50%;
niobium oxide: from 2% to 20%;
oxide of the element M: up to 20%; and
the remainder as zirconium oxide.

4. The composition as claimed in claim 1, wherein after calcination at 800° C. for 4 hours, the composition exhibits an acidity of at least 6×10⁻² this acidity being expressed in ml of ammonia per m² of composition.

5. The composition as claimed in claim 1, wherein the composition comprises niobium oxide in a proportion by weight of between 3% and 15%.

6. The composition as claimed in claim 2, wherein the composition comprises cerium oxide in a proportion by weight of at least 65% and niobium oxide in a proportion by weight between 2% and 12%.

7. The composition as claimed in claim 6, wherein the composition comprises cerium oxide in a proportion by weight of at least 70%.

8. The composition as claimed in claim 6, wherein the composition comprises niobium oxide in a proportion by weight of less than 10%.

9. The composition as claimed in claim 6, wherein the composition exhibits an acidity, measured by TPD analysis, of at least at least 6×10⁻² ml of ammonia per m².

10. The composition as claimed in claim 4, wherein after calcination at 800° C. for 4 hours, the composition exhibits a surface area of at least 15 m²/g.

11. The composition as claimed in claim 4, wherein after calcination at 800° C. for 4 hours, the composition exhibits a surface area of at least 20 m²/g.

12. The composition as claimed in claim 4, wherein after calcination at 1000° C. 4 hours, the composition exhibits a surface area of at least 2 m²/g.

13. A catalytic system comprising a composition as defined in claim 1.

14. A method for treating a gas, comprising treating the gas using as catalyst for the oxidation of CO and hydrocarbons present in the gas, a catalytic system as claimed in claim 13.

15. A process for the treatment of a gas comprising using a catalytic system as claimed in claim 13 for the decomposition of N₂O, for the adsorption of NOₓ and CO₂.

16. A process employing one of the following reactions: a water gas reaction, a steam reforming reaction, an isomerization reaction or a catalytic cracking reaction, the process comprising using a catalytic system as claimed in claim 13 in the process.

17. A three-way catalysis process for the treatment of gasoline engine exhaust gases, the process comprising using a catalytic system as claimed in claim 13 for carrying out the process.
